(19) United States
(12) Patent Application Publication
(10) Pub. No.: US 2010/0200617 A1
(43) Pub. Date: Aug. 12, 2010

(54) Cartridge piston with venting device

(76) Inventor: Martin Schär, Hunenberg (CH)

Correspondence Address: Francis C. Hand, Esq.;c/o Carella, Byrne, Bain, Gilfillan, Cecchi,, Stewart & Olstein, 5 Becker Farm Road, Roseland, NJ, 07068, US

(21) Appl. No.: 12/658,477

(22) Filed: Feb. 9, 2010

(30) Foreign Application Priority Data
Feb. 11, 2009 (EP) 09152496.7

(51) Int. Cl. B67D 7/60; G01F 11/00

(52) U.S. Cl. 222/387; 222/386

(57) ABSTRACT

The cartridge piston includes a piston jacket and a venting device made as a cut-out and arranged at the piston jacket. Radial passages and one or more ring shaped passages in the surface of the piston that faces the media within a cartridge communicate with the cut-outs to vent air from the cartridge upon installation of the piston.

The invention relates to a cartridge piston having a venting device for use in a cartridge or in a dispensing device. The cartridge can be considered as a storage container for one or more components to be mixed which are in particular located in a two-component cartridge.

Such a cartridge piston is known, for example, from DE 200 10 417 U1. The piston has a first piston part which is provided with a sealing lip which is designed for contact with the cartridge wall. The first piston part has a circular cylindrical recess. Furthermore, the piston has a second piston part which has a circular cylindrical wall part which is latched to the first piston part at the base of the recess and thus forms a latch connection. The circular cylindrical wall part merges in arcuate form into a valve pin of a venting valve. This valve pin passes through a cylindrical bore arranged along the piston axis in the first piston part and has a valve cone which comes into contact with a valve lip of the first piston part. The latch connection is interrupted by a small air passage which forms a filter path between the circular cylindrical wall part and the first piston part. The filter path is made up of narrow passages at the inner wall of the circular cylindrical wall part.

If the cartridge piston is inserted into a cartridge, the valve pin is moved such that the venting valve is opened and the air enclosed between the filler compound and the cartridge piston escapes via the air passage and the filter path and is discharged via the venting valve. If the cartridge piston is pressed toward the filler compound, it can move via the air passage up to the filter path, but is prevented by the labyrinth formed by the filter path from being discharged through the venting valve.

Such a venting valve in accordance with the above embodiment is manufactured as a component to be produced separately in addition to the cartridge piston. The manufacture of the venting valve thus requires a separate tool, which has the consequence that the cartridge piston is expensive in its manufacture since both a tool for the cartridge piston and a tool for the venting valve have to be provided. In addition, before the use of the cartridge piston in a dispensing cartridge, the venting valve has to be inserted into the cartridge piston; an assembly step must thus be provided.

Accordingly, it is the object of the invention to provide a cartridge piston with a venting device which is easy and economical to manufacture.

Briefly, the invention provides a cartridge piston that includes a piston jacket and a venting device, with the venting device being formed as a cut-out which is arranged at the piston jacket. The venting device is thus made as part of the cartridge piston and forms a unit with the cartridge piston.

This venting device can include a sealing lip with a plurality of venting passages. The venting passages are made as a barrier against the passage of filler compound. Furthermore, the venting device can include a valve lip. The valve lip preferably has a smaller cross-section than the sealing lip or each of the sealing lips so that it can open in a similar manner to a membrane at a specific air pressure so that the air can pass between the cartridge wall and the sealing lip.

A substantial advantage of the cartridge piston of the invention is founded in the fact that the cartridge piston can be inserted into the cartridge in a single work step after or while the cartridge is being filled with filler compound. The filling of the cartridge is hereby simplified. The filling of the cartridge can take place either via a dispensing opening provided in the cartridge or directly into the inner space of the cartridge before insertion of the cartridge piston. In both cases, the venting, that is the escape of air or other gases, takes place between the cartridge piston and the filler compound as soon as a pressure acts on the enclosed gas volume, whether from the filler compound side or from the moving cartridge piston side.

The media-side surface of the cartridge piston, also called a dome, should correspond to the inner shape of the cartridge. The media-side surface of the cartridge piston should in particular be designed such that, on a complete emptying of the cartridge, this media-side surface lies as much as possible on the discharge end of the cartridge in order to avoid as much as possible that filler compound remains in the cartridge after the expulsion process has been concluded. The venting passages are also made as narrow as possible for this reason so that the loss volume of the filler mass is reduced to a minimum.

The cartridge piston is also characterized by a shallower construction in comparison with the prior art. The filling volume in the cartridge is thus also enlarged in addition to the achieved material saving in the manufacture of the piston. The piston is nevertheless guided in a manner secure against tilting in the cartridge because a plurality of guide elements is provided at the piston jacket. These guide elements simultaneously have the function of sealing lips to prevent a discharge of the filler compound from the inner space of the cartridge closed by the cartridge piston.

The cartridge piston can thus be manufactured by means of a single tool in the injection molding process. Any subsequent assembly steps can herewith be fully dispensed with. In addition, the injection molding process is simplified if a hollow space which extends along the piston axis and which would have been designed for the reception of a venting valve can be omitted. In this case, the injection point for the polymer melt in the injection molding tool can namely lie along the piston axis. The entry of polymer melt into the inner space of the tool of the injection molding tool takes place at the injection point. The inner space of the tool has the shape of the cartridge piston. The polymer melt flows starting from this injection point and fills the whole inner space of the tool. In this respect, a blind hole bore arranged opposite prevents an unwanted formation of a free jet which would have an unfavorable effect on the filling behavior of the polymer melt in the tool cavity. The polymer melt can be subject at least partly to a cooling so that it solidifies such that the completed cartridge piston can be removed from the inner tool space, that is can be demolded.

Since the venting device is made as a cut-out in the piston jacket, the local change of the wall thickness thereby caused is negligible so that no special adaptations to the tool design or to the cooling of the injection molding tool have to be carried out for the cartridge piston. The possible simplification of the injection molding tool on the basis of the shape of the venting device surprisingly even leads to a more economic manufacture of the cartridge piston. In accordance with the invention, no central opening has to be provided for the cartridge piston which provides room for the venting valve to be manufactured separately. Due to this central opening, it was not possible to find an feed point in the prior art starting from which the polymer melt could spread uniformly in all spatial directions since the opening for the venting valve has to be provided at precisely that point at which the central feed point would have to be provided.

It has moreover become possible by the integration of the function of the venting device into the cartridge piston fully to dispense with two manufacturing steps, namely the separate manufacture of a venting valve such as is required in the prior art and the assembly of the venting valve and of the cartridge piston. This function integration thus results in a simplification of the cartridge piston and thus in a more economic manufacture thereof.

A plurality of cut-outs can advantageously be arranged at the piston jacket. The flow path for the gaseous medium to be removed is hereby reduced. The gaseous medium is generally air which has collected between the filler compound and the cartridge piston; however, the venting device works in the same way for other gaseous media.

The cut-outs can be arranged at the same spacing from one another. This arrangement has the advantage that the maximum flow path for a gas bubble or for a gas cavity is reduced.

A cut-out can be made as a passage which is located at least partly on a media-side surface. This embodiment variant has the advantage that air can be conducted fast to the cut-out from any location on the media-side surface. It is hereby avoided that the air has to flow through the filler compound to the cut-out. In particular, when the filler compound is viscous, substantial delays in the venting are otherwise to be expected due to the flow resistance of the filler compound.

The passage can extend as a radial passage in the radial direction from the piston jacket to the piston axis on the media-side surface of the cartridge piston. Air is conducted directly to the cut-outs at the piston jacket through the radial passage.

The passage can be made as a slit with an open cross-section. The passage is thus accessible for air at every point of the piston radius so that air can be removed fast and uniformly from most locations on the media-side surface. The depth of the passage can reduce from a central region, which contains the piston axis, in the direction of the piston jacket, whereby the removal of air can be improved if the filler compound is first arranged in the middle piston region, that is a region which contains the piston axis, or close to the same.

The passage can be made as a ring-shaped passage. Air cushions which are located close to the piston axis can be conducted in the direction of one or more radial passages by means of the ring-shaped passage. For this purpose, the ring-shaped passage can in particular have a radius of a maximum of ½, preferably of a maximum of ⅓, particularly preferably of a maximum of ¼, of the piston radius. A plurality of ring-shaped passages can naturally also be arranged concentrically to one another.

A second ring-shaped passage can be provided whose radius amounts to at least ⅔, preferably at least ¾, particularly preferably at least ⅘, of the piston radius. This second ring-shaped passage, in particular, serves for the direct guidance of the air to the cut-out or cut-outs at the piston jacket. It can be avoided by means of the second ring-shaped passage that air collects at points at the piston jacket at which no cut-out is provided.

The radial passage preferably intersects at least one of the ring-shaped passages so that the radial and ring-shaped passages are connected to one another.

The region inside the first ring-shaped passage can contain a feed point.

The second ring-shaped passage moreover also serves as a hollow for the movable design of the peripheral lip or of a plurality of peripheral lips, which can optionally be adapted to the inner wall of the cartridge.

The media-side surface is preferably not normal to the piston axis, but has conical sections. The total media-side surface is particularly preferably conical, with the tip of the cone lying on the piston axis. If the cartridge piston is inserted into a cartridge filled with filler compound, the tip of the cone comes into contact with the filler compound first. The air enclosed between the filler compound and the cartridge piston can then move via the first ring-shaped passage, the radial passage or passages as well as the second ring-shaped passage to the cut-outs in the piston jacket and escape through them in the direction of the conveying side.

The piston jacket can include at least one lip which is designed for the contact with a cartridge wall at the peripheral side. The lip should prevent filler compound from moving from the media side to the conveying side of the cartridge piston.

At least one further sealing lip can be arranged at the piston jacket and contains one or more openings for venting and/or a sealing element, in particular an O ring. The sealing element can be placed into a ring groove, with the ring groove being able to have venting passages. The use of an O ring as a sealing element serves for the increase in the leak tightness, in particular, with low-viscosity filler compounds. The sealing element is assembled in the ring groove provided for this purpose in a separate work step. The ring groove is naturally only one possible embodiment for a reception means of a sealing element.

This sealing lip and/or the sealing element serves/serve as a further barrier for the filler compound and additionally serves/serve for the guidance of the cartridge piston along the inner wall of the cartridge. One or more sealing lips also contribute to the increase in the security against tilting of the cartridge piston.

At least one valve lip can be arranged at the piston jacket on the conveying side and is designed for the contact with the cartridge wall at the peripheral side. This valve lip should only be able to allow air through in the direction of the conveying side and moreover satisfies the function as a piston security or as an abutment. It is hereby prevented that the piston can slip out of the cartridge, for example on the filling of the cartridge from the discharge openings of the conveying medium.

The piston jacket can be connected to the media-side surface via a plurality of webs. The webs have the function of stiffening ribs and can also serve as a support for a plunger which can be provided for the dispensing of the filler compound.

The cartridge piston can have a surface, which contains a depression, disposed opposite the media-side surface. Such a depression can be provided to reduce the material requirements for the manufacture of the cartridge piston. Furthermore, a material accumulation can be avoided which can result in collapse points and deformation of the mold and which would result in an increase of the cooling time during the injection molding process and during the cooling phase which optionally follows it before the demolding. An increase in the time requirement for the cooling phase can have the consequence of an extension of the cycle time for the total injection molding process, which would have the consequence of making the manufacture of the cartridge piston more expensive.

The cartridge piston can, in particular, be used for the mixing of a curing mixed product from flowable components.

A further possible use of the cartridge piston is the mixture of impression compounds in the dental field or the mixture of multicomponent adhesives.

The invention will be explained in the following with reference to the drawings. There are shown:

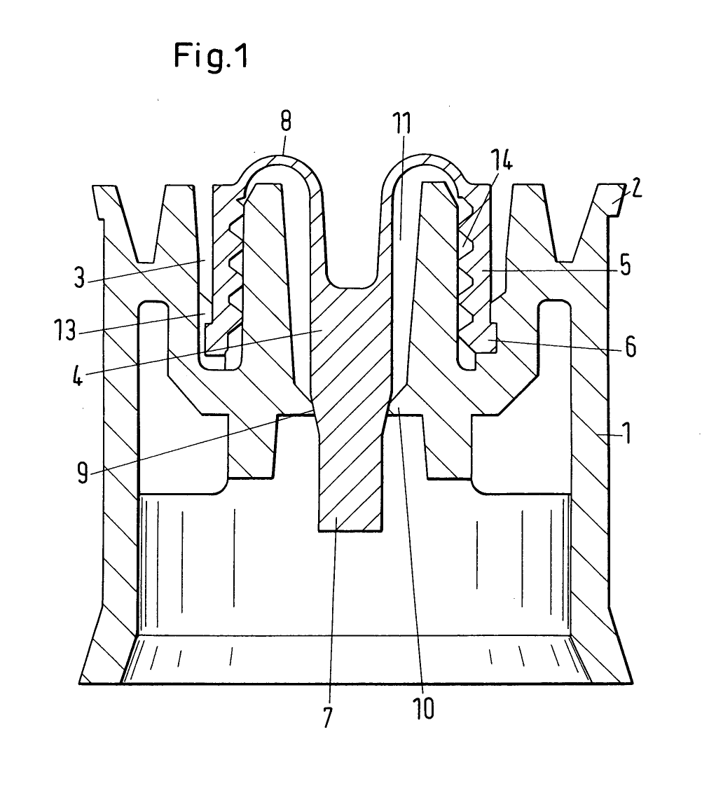

FIG. 1 illustrates a cross-sectional view of a cartridge piston in accordance with the prior art;

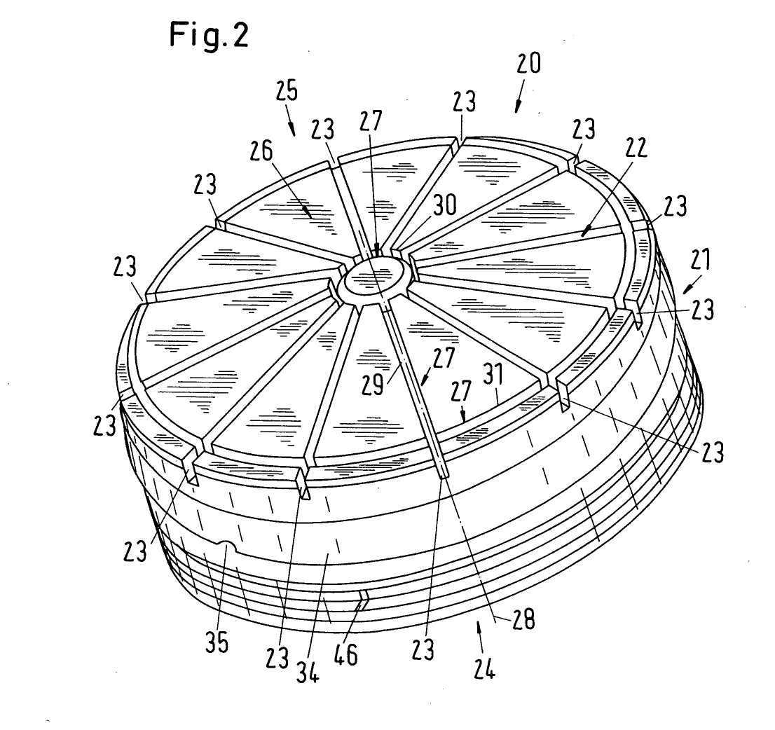

FIG. 2 illustrates a perspective view of a cartridge piston in accordance with the invention;

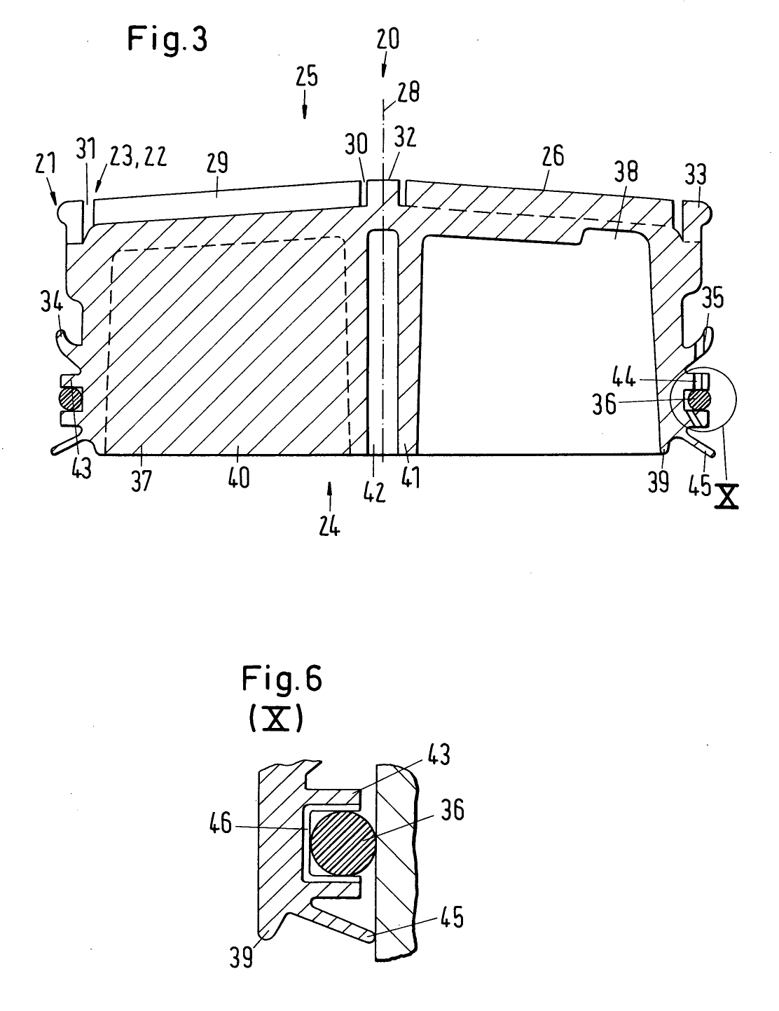

FIG. 3 illustrates a cross-sectional view of the cartridge piston of FIG. 2;

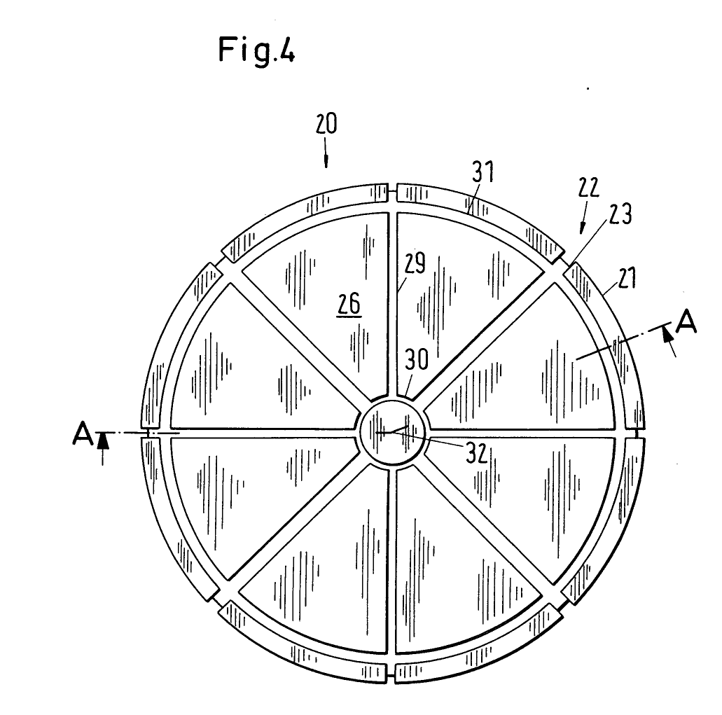

FIG. 4 illustrates a view of the cartridge piston of FIG. 2 from the media side;

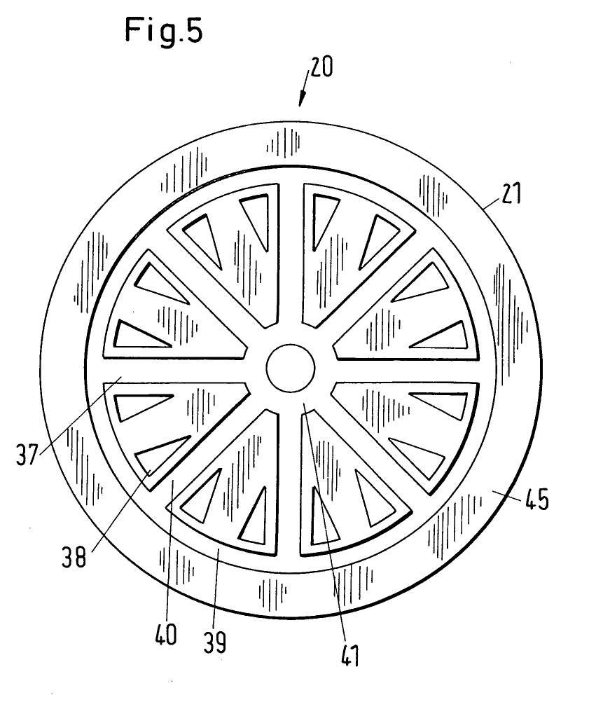

FIG. 5 illustrates a view of the cartridge piston of FIG. 2 from the conveying side;

FIG. 6 illustrates a detail view X of FIG. 3; and

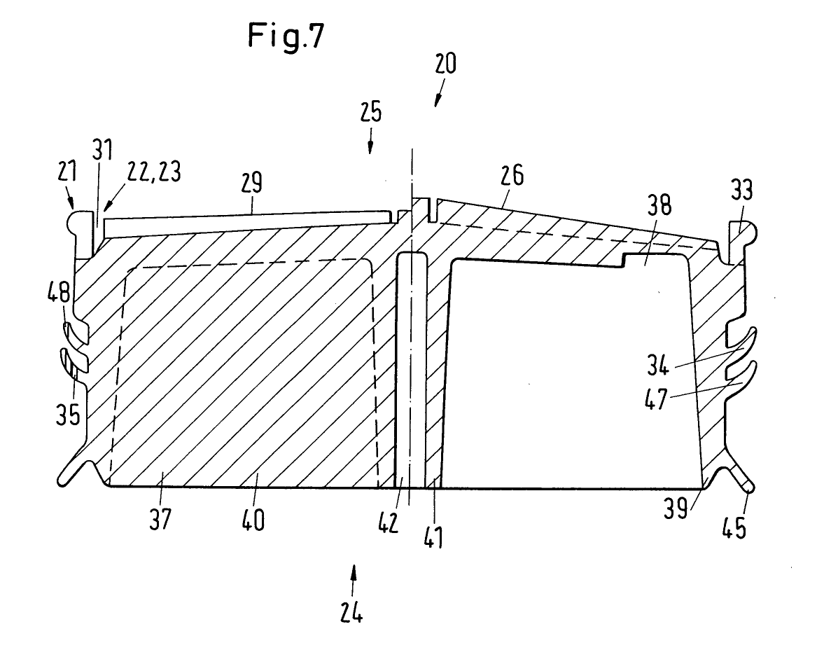

FIG. 7 illustrates a cross-sectional view of modified cartridge piston in accordance with the invention.

Referring to FIG. 1, the known cartridge piston has a first piston part 1 which is provided with a sealing lip 2 which is designed for contact with a cartridge wall (not shown). The first piston part 1 has a circular cylindrical recess 3. Furthermore, the piston has a second piston part 4 which has a circular cylindrical wall part 5 which is latched to the first piston part 1 at the base of the recess 3 and thus forms a latch connection 6. The circular cylindrical wall part 5 merges in arcuate form into a valve pin 7 and forms an arcuate transition region 8. This valve pin 7 passes through a cylindrical bore 11 arranged along the piston axis in the first piston part 1 and has a valve cone 9 which comes into contact with a valve lip 10 of the first piston part 1.

The latch connection 6 is interrupted by a small air passage 13 which forms a filter path 14 between the circular cylindrical wall part 5 and the first piston part 1. The filter path 14 is made up of narrow passages at the inner wall of the circular cylindrical wall part 5.

If the cartridge piston is inserted into a cartridge, the valve pin 7 is moved such that the venting valve is opened and the air enclosed between the filler compound and the cartridge piston escapes via the air passage 13 and the filter path 14 and is discharged via the venting valve. If the cartridge piston is pressed toward the filler compound, it can move via the air passage 13 up to the filter path 14, but is prevented by the labyrinth formed by the filter path 14 from being discharged through the venting valve.

Referring to FIG. 2, the cartridge piston 20 in accordance with the invention includes a piston jacket 21 and a venting device 22, with the venting device 22 being made as a cut-out 23 which is arranged at the piston jacket 21. The venting device 22 is thus made as part of the cartridge piston 20 and forms a unit with the cartridge piston 20. The cartridge piston 20 is designed for reception in a cartridge (not shown).

The cartridge usually has the shape of a hollow cylinder in which a filler compound can be located. The filler compound can be dispensed via a usually closable discharge opening at an end of the cartridge. If the cartridge is made as a coaxial cartridge, a further hollow cylinder is located at the interior of the hollow cylinder and is designed for the reception of a further filler compound. In this case, the filler compound in the outer hollow cylinder includes a first component or a first mixture of a plurality of components. The filler compound in the inner hollow cylinder includes a second component or a second mixture of a plurality of components. The two filler compounds thus differ from one another and should where possible not come into contact with one another before their common dispensing.

In accordance with a variant, a cartridge can also contain a plurality of hollow cylinders which are arranged next to one another and which contain chambers for a respective first and second component or a first and second mixture. More than two chambers can naturally also be provided. The chambers do not necessarily have to be made as hollow cylinders; they can also only include parts of a hollow cylinder or have a shape of the hollow space differing from the cylindrical shape.

The cartridge piston 20 is thus displaceable in its hollow space. For this purpose, a pressure is exerted onto the conveying side of the cartridge piston by a dispensing device. A dispensing plunger can, for example, be used as the dispensing device which is made as part of a commercial metering pistol. The conveying side 24 of the cartridge piston is disposed opposite the media side 25 of the cartridge piston. The media side 25 includes the media-side surface 26 of the cartridge piston which comes into contact with the filler compound at least during the dispensing. The venting device 22 is preferably made as a cut-out 23 which is visible on the media side 25. The cut-out 23 is thus arranged on the media-side surface 26 of the piston. In the region of the cut-out 23, the contact of the piston jacket with the inner wall of the cartridge is locally interrupted so that the air can escape through the cut-out.

A plurality of cut-outs 23 can be arranged at the piston jacket. The air can be discharged through each of the cut-outs 23. FIG. 2 and FIG. 3 show an embodiment which contains a plurality of cut-outs 23. The shape of individual cut-outs can naturally differ from the shape of other cut-outs. Some of the cut-outs can, for example, have a larger discharge cross-section.

The cut-outs 23 can be arranged at the same spacing from one another. In accordance with FIG. 2 or FIG. 4, a plurality of cut-outs 23 are located at the piston jacket 21 which each have the same spacing from the adjacent cut-outs. The number and the spacing of the individual cut-outs 23 from one another are dependent on the air amount to be led off to be expected as well as on the size of the cartridge piston 20, in particular of the piston diameter.

The cut-out 23 can be made as a passage 27 which is located at least partly on a media-side surface 26. The passage 27 can facilitate the venting if air is located in a region close to the piston axis 28. This air is introduced into the passage 27 which is connected to the cut-out 23. This arrangement is in particular advantageous when the filler compound is viscous, that is the air only moves through the filler compound slowly. The flow resistance of the filler compound is high in this case. The passage 27 thus presents itself as an alternative flow path for the air which does not lead through the filler compound. The venting speed can thus in particular be increased for viscous filler compounds.

The passage 27 extends in FIG. 2, FIG. 3 or FIG. 4 as a radial passage 29 in the radial direction from the piston jacket 21 to the piston axis 28 on the media-side surface 26 of the cartridge piston. The passage 27 is made as a slit with an open cross-section. The slit has a small slit width so that filler compound can enter much more slowly into the passage than the air and the filler compound is thus only completely taken up by the passage when the air has already escaped.

The passage can be made as a first ring-shaped passage 30.

The first ring-shaped passage 30 can have a radius of a maximum of ½, preferably of a maximum of ⅓, particularly preferably of a maximum of ¼, of the piston radius. The piston radius is the normal spacing measured from the piston axis 28 to the piston jacket 21 measured at a point at which the piston jacket 21 is designed for contact with the inner wall of the cartridge.

A second ring-shaped passage 31 is provided whose radius amounts to at least ⅔, preferably at least ¾, particularly preferably at least ⅘, of the piston radius. In addition, the second ring-shaped passage 31 serves as a hollow for the movable design of a lip 33 extending between the second ring-shaped passage 31 and the piston jacket 21. The lip 33 can be matched to an inner side of a cartridge wall in which the piston is guided.

The radial passage 29 intersects at least one of the ring-shaped passages 30 and 31 so that a fluid-permeable connection of the passages is formed.

The region of the media-side surface 26 which lies within the first ring-shaped passage 30 can contain a feed point 32. Starting from this feed point 32, the polymer melt flows in the injection molding tool for so long until the mold of the injection molding tool corresponding to the cartridge piston is completely filled with polymer melt. In this respect, a blind hole bore 42 (FIG. 3) arranged disposed opposite the feed point 32 on the conveyor side prevents an unwanted free jet formation which would have an unfavorable effect on the filling behavior during the injection molding in the manufacture of the piston. The feed point 32 can, in accordance with this embodiment, be disposed on the piston axis 28 so that the flow path of the polymer melt is the same for all points disposed on the same periphery on the manufacture of the piston due to the usually present rotational symmetry. The injection molding process can accordingly be substantially simplified with respect to a cartridge piston from the prior art due to this arrangement of the feed point 32 on or in direct proximity to the piston axis 28.

The piston jacket 21 thus advantageously includes at least the lip 33 which is designed for contact with the inner side of the cartridge wall at the peripheral side. The lip 33 contains the cut-out 23 or the plurality of cut-outs 23, which is shown in FIG. 2 to FIG. 4.

At least one further sealing lip 34 which contains an opening 35 for venting can be arranged at the piston jacket. This opening can be made as an indentation as is shown in FIG. 2 or can include a bore in the wall of the sealing lip 34 in accordance with FIG. 3. This opening 35 can also be made as a hollow with a breakthrough to the oppositely disposed side of the sealing lip 34. The opening or hollow with breakthrough can also be arranged in the foot region of the sealing lip 34. A plurality of such openings can naturally be provided in the sealing lip 34 and optionally further sealing lips. The openings 35 are preferably offset to the cut-outs 23. A labyrinth is hereby formed so that only the air is discharged through the openings 35, but any filler compound is held back by the labyrinth.

Additionally or alternatively thereto, a sealing element 36, in particular an O ring, can be arranged, as is shown in FIG. 3. This solution in accordance with FIG. 3 can be used when media of lower viscosity are used as filler compounds or when the sealing lip is made of soft material or is thin-walled so that it loses the contact with the inner wall of the cartridge by the pressure of the outflowing air. If a discharge of filler compound through this sealing lip 34 should occur in this respect, the sealing element 36 serves for the sealing with respect to a discharge of filler compound onto the conveyor side 24. If an O ring is used as the sealing element 36, air can be led off through at least one venting passage 44 which is integrated in the ring groove 43 for the reception of the sealing element 36.

It is also shown in FIG. 3 that the piston jacket 21 can be connected via a plurality of webs 37 to the media-side surface. A view of the webs 37 is also shown in FIG. 5.

FIG. 4 shows a view of the media side 25 of the cartridge piston 20 of FIG. 2 or FIG. 3. FIG. 4 further shows the course of the first ring-shaped passage 30, the radial passages 29 which form the connection to the second ring-shaped passage 31 as well as the cut-outs 23 to which the radial passages 29 lead. The cut-outs are arranged at the piston jacket 21. FIG. 4 shows that the radius in the region of the cut-out is smaller than the piston radius. That radius is defined as the piston radius which has the largest normal spacing between the piston jacket 21 and the piston axis 28. The piston radius after the insertion of the piston into the associated cartridge corresponds to the radius of the inner wall of the associated cartridge. FIG. 4 furthermore shows the position of the feed point 32 which is preferably arranged around the piston axis 28.

FIG. 5 shows the surface of the cartridge piston 20 which is disposed opposite the media-side surface 26 and which forms the conveyor side 24. The piston jacket 21 is formed in this representation by a valve lip 45 which is of thinner design and which does not contain any opening. In this respect, of thinner design means that the valve lip 45 has a smaller wall thickness than the lip 33. Accordingly, the valve lip 42 is permeable for air which should move from the media side 25 to the conveying side 24. This air is increasingly compressed by the advancing conveying process. The adhesion to the inner wall of the cartridge can be interrupted locally at times by the pressure of this compressed air so that the air can be discharged through the valve lip to the conveying side.

The piston jacket 21 ends in a ring-shaped web 39 from which radial webs 40 start which open into an inner ring-shaped web 41. This web construction contributes to the shape design suitable for plastic and has a comparable stiffness to a cartridge piston which is completely filled with material. It has even proved to be advantageous to provide cut-outs 38 to avoid material accumulations in the region of the transition from the media-side surface 26 to the piston jacket 21.

The manufacture of the cartridge piston preferably takes place in the injection molding process. The cartridge piston is in one part; however, during the injection molding process, a plurality of components can also be used, for example while using the two-component injection molding process. The two components can contain a dimensionally stable plastic, that is in particular a polymer, which withstands the pressure acting on the cartridge piston on the filling and on the dispensing, as well as a flexible or elastic plastic which adapts to irregularities or is suitable to compensate small slanted positions of the cartridge piston. A TPE (thermoplastic elastomer) is named as an example for such a flexible plastic.

The cartridge piston can preferably also contain foamed plastic, whereby the material requirement for the manufacture of the cartridge piston can be further reduced.

FIG. 6 shows a variant as a detail X of FIG. 3 In this variant, a venting passage 46 is shown instead of a venting bore 44. One or more such venting passages 46 can be arranged in the O ring groove 43. Air moves from the media side 25 to the conveying side 24 of the piston through these venting passages 46. A depth of the venting passage of a maximum of 0.1 mm, preferably of a maximum of 0.05 mm, is sufficient in this respect.

Referring to FIG. 7, wherein like reference characters indicate like parts as above, the cartridge piston may be provided with a further lip 47 in addition to the lip 34 instead of an O ring. Each of the lips 34, 47 can have at least one opening 35 or a groove 48 which can also be made as a cut-out or hollow. The openings or grooves of adjacent lips can also be arranged offset to one another. More than two lips can naturally also be provided.

FIG. 7, right hand side, shows that the radial passage 29 has, in the direction of view from the piston axis 28 toward the piston jacket 21, a substantially continuously reducing depth. This variant is in particular suitable for viscous filler compounds. In this case, the surface of the filler compound is generally not disposed on a plane normal to the piston axis, but has a curved surface which has a central indentation. That is, the filler compound is closer to the cartridge piston in the region of the piston axis 28 than the filler compound in regions which are disposed close to the inner wall of the cartridge. If such a filler compound impacts the cartridge piston, it is first to come into contact with the feed point 32. Any air between the filler compound and the cartridge piston is displaced into the radial passage with progressing contact, that is a successive reduction of the spacing between the filler compound and the cartridge piston. Since the filler compound first impacts the radial passage 29 in a region close to the piston axis 28, it can move into the radial passage 29 and push air still present in the passage 29 in the direction of the inner wall of the cartridge. Since the radial passage 29 becomes continuously flatter, less filler compound is required for the regions of the passage 29 close to the wall so that the passage 29 can be filled by filler compound largely simultaneously. It can hereby be avoided that any air inclusions remain in the filler compound.

FIG. 7, left hand side, shows that the radial passage 29 has, in the direction of view from the piston axis 28 toward the piston jacket 21, a substantially continuously increasing depth. This variant is in particular to be preferred when the filler compound is of low viscosity. In this case, the surface of the filler compound is disposed substantially in a plane which is normal to the piston axis when the cartridge is vertical. In this case, air has to be removed simultaneously from the intermediate space between the surface of the filler compound and the cartridge piston. Since the air volume increases in the direction of the inner wall of the cartridge because the venting should take place at the piston jacket, the depth of the radial passage 29 must increase in this case to push out the increasing gas volume in the direction of the inner wall of the cartridge.

What is claimed is:

1. A cartridge piston including
a piston jacket having a longitudinal piston axis and a media side surface; and
a venting device for venting air from said media side surface side, said venting device including at least one cut-out in said piston jacket and a radial passage in said media side surface extending in a radial direction from said cut-out in said piston jacket towards said piston axis.

2. A cartridge piston in accordance with claim 1 having a plurality of said cut-outs in said piston jacket and a plurality of radial passages in said media side surface, each said radial passage communicating with a respective one of said plurality of cut-outs.

3. A cartridge piston in accordance with claim 2 wherein said radial passages are arranged at the same spacing from one another.

4. A cartridge piston in accordance with claim 1 wherein said radial passage is a slot with an open cross-section.

5. A cartridge piston in accordance with claim 1 further including a first ring-shaped passage in said media side surface in communication with said radial passage.

6. A cartridge piston in accordance with claim 5 wherein said first ring-shaped passage has a radius of a maximum of ¼ of the piston radius.

7. A cartridge piston in accordance with claim 5 further comprising a second ring-shaped passage in said media side surface having a radius of at least ⅘ of the piston radius.

8. A cartridge piston in accordance with claim 7 wherein said radial passage intersects said second ring-shaped passage.

9. A cartridge piston in accordance with claim 7 further comprising a feed point within said first ring shaped passage.

10. A cartridge piston in accordance with claim 1 further comprising at least one lip on said piston jacket for contacting a cartridge wall at a peripheral side.

11. A cartridge piston in accordance with claim 10 further comprising at least one further sealing lip on said piston jacket for contacting a cartridge wall at a peripheral side, said further sealing lip having an opening for venting.

12. A cartridge piston in accordance with claim 1 further comprising a sealing element peripherally of said piston jacket.

13. A cartridge piston in accordance with claim 12 wherein said sealing element is an O-ring.

14. A cartridge piston in accordance with claim 1 further comprising a plurality of webs connecting said piston jacket and said media side surface.

15. A cartridge piston in accordance with claim 1 further comprising a conveyor side surface on an opposite side from said media side surface and a depression in said conveyor side surface.

16. A cartridge piston comprising
a plastic cylindrical piston jacket having a longitudinal piston axis;
a media side surface transverse to said piston jacket;
a plurality of cut-outs in said piston jacket for venting air radially of said piston jacket;
a plurality of radially disposed passages in said media side surface in communication with a respective cut-out for venting air radially of said surface;
a ring-shaped passage in said media side surface in communication with said passages and said cut-outs for conveying air therebetween.

17. A cartridge piston as set forth in claim 16 wherein said cut-outs in said piston jacket define a plurality of peripherally spaced resilient lips therebetween for sealingly engaging a cartridge wall.

18. A cartridge piston as set forth in claim 16 further comprising a peripherally disposed sealing lip extending radially outwardly of said piston jacket at an intermediate point thereof for sealingly engaging a cartridge wall, said lip having an opening at an end thereof for venting air therethrough.

19. A cartridge piston as set forth in claim 16 further comprising a thin peripherally disposed sealing lip at a base of said piston jacket directed in a direction away from said media side surface and being resiliently flexible radially inwardly under a predetermined pressure on said lip.

20. A cartridge piston as set forth in claim 16 further comprising a conveying side surface within said piston jacket and on an opposite side from said media side surface, a plurality of longitudinally disposed webs extending between said piston jacket and said conveying side surface,
